(19) United States
(12) Patent Application Publication
(10) Pub. No.: US 2018/0365138 A1
(43) Pub. Date: Dec. 20, 2018

(54) CLOUD-BASED TESTING

(71) Applicant: Hewlett Packard Enterprise Development LP, Houston, TX (US)

(72) Inventors: Mark Bain, Houston, TX (US); David Galvan, Houston, TX (US); Chris Nelson, Allen, TX (US); Dau-Yueh Wu, Taipei City (TW)

(21) Appl. No.: 16/060,922

(22) PCT Filed: Dec. 8, 2015
(86) PCT No.: PCT/US2015/064539

§ 371 Date: Jun. 8, 2018

(51) Int. Cl. G06F 11/36; G06F 9/455; G06F 9/50; G06F 9/54

(52) U.S. Cl. CPC G06F 11/3688; G06F 9/45558; G06F 9/5077; G06F 2009/45587; G06F 2009/45595; G06F 2009/45583; G06F 9/545

(57) ABSTRACT

An example device comprises a processor to execute a test plan obtained from a user of a user network; and a test platform having a pool of selected virtualized resources based on the test plan. The pool of virtualized resources can include virtualization of at least one cloud-based resource and at least one non-cloud resource, where the virtualization of the at least one non-cloud resource comprises virtualizing a resource from the user network.

### BACKGROUND

Cloud-based computing and storage provides users with flexibility to use shared resources. Such arrangements can be beneficial for numerous reasons. Use of cloud-based resources allows users to have access to a large variety of resources which may be shared. Further, the cost of use of such resources may be significantly lower than purchase of dedicated resources. Thus, a user may develop an infrastructure of resources selected from a large variety of resources available via a cloud.

### BRIEF DESCRIPTION OF THE DRAWINGS

For a more complete understanding of various examples, reference is now made to the following description taken in connection with the accompanying drawings in which:

FIG. 1 illustrates an example device for cloud-based testing:

FIG. 2 illustrates an example system including the example device of FIG. 1 for cloud-based testing;

FIG. 3 is a flow chart illustrating an example process for cloud-based testing;

FIG. 4 is a flow chart illustrating an example process for forming a pool of virtualized resources for cloud-based testing; and

FIG. 5 illustrates a block diagram of an example system with a computer-readable storage medium including instructions executable by a processor for cloud-based testing.

### DETAILED DESCRIPTION

Various examples described herein allow cloud-based testing of resources allocated to a particular user where at least some of the resources that are tested are part of the user's local network and others are part of the cloud. Thus, a single testing solution can be used to test all resources for a user. A user on a local network is provided with shared resources on a cloud network. The user's local network also includes resources that may be tested. The user can provide a test plan for use by a cloud-based server. Upon receiving instructions from the user, the server accesses the test plan which may be located on the cloud or provided by the user. Based on the test plan, the server may compile a list of resources to be tested and additional support resources that may be needed for the test plan. The server can then access resources that are within the cloud. The server can additionally access resources within the user's local network. These resources are not shared and are exclusive to the user. The server uses an abstraction layer to create a pool of virtualized resources that includes cloud-based resources, as well as non-cloud resources, such as resources on the user's network. The server can then execute the test plan and provide results back to the user.

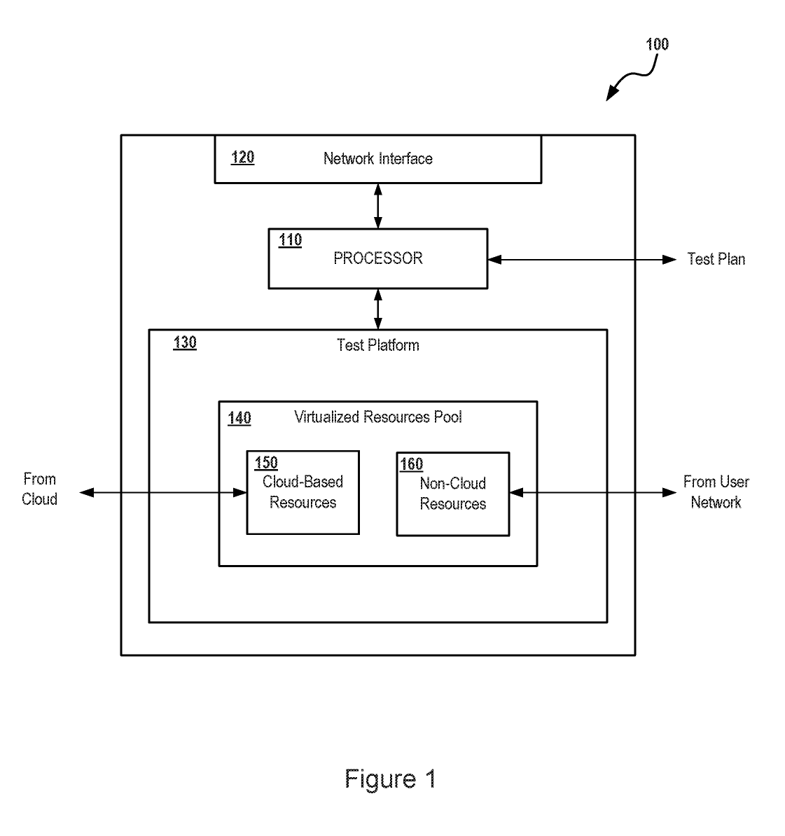

Referring now to the figures, FIG. 1 illustrates an example testing device for executing cloud-based testing. In various examples, the example testing device 100 may be a cloud-based device, such as a cloud server. The example testing device 100 may be offered by a service provider for providing a platform for testing of a set of resources. The resources to be tested may include hardware, such as servers, various interconnect devices such as network switches, storage devices, user terminals, printers or the like.

The example testing device 100 of FIG. 1 includes a processor 110, which may be a central processing unit (CPU) for executing various instructions provided in software, firmware, etc. The processor 110 may operation according to an operating system.

The example testing device 100 of FIG. 1 may communicate with other devices and networks using a network interface 120, for example. In various examples, the network interface 120 may allow secure communication between the example testing device 100 and other devices and networks.

The example testing device 100 further includes a test platform 130 to provide for testing of, for example, proposed infrastructure or systems of resources. The test platform 130 may be implemented with hardware, software, firmware or a combination thereof. In the example testing device 100, the processor 110 and the test platform 130 may test a proposed infrastructure or system of resources based on a test plan received from a user. As described in greater detail below, the processor 110 may either receive or access the test plan from the user requesting the testing.

The test plan may be used by the processor 110 to form a virtualized resources pool 140 in the test platform 130. In this regard, the test plan may, at least in part, dictate the resources needed to execute the test plan. In various examples, the virtualized resources pool 140 may include at least one virtualized cloud-based resource 150 and at least one virtualized non-cloud resource 160. As used herein, a cloud-based resource 150 may include any hardware, software, service or other resource that is available to a user through a cloud. In various examples, the cloud-based resource 150 may be a resource that is shared or is outside the user's local network. Further, in various examples, a non-cloud resource 160 may include any hardware, software, service or other resource that is within the user's local network. The non-cloud resource 160 may be a resource that is dedicated to the user or limited to use by other users within the user's network. In various examples, the processor 110 may form the virtualized resources pool 140 in an abstraction layer. Thus, while the resources that are virtualized may exist in disparate locations, the abstraction layer can facilitate interoperability.

FIG. 1 illustrates the test plan accessed by the processor 110. Further, the virtualized cloud-based resources 150 are obtained by the test platform through a cloud, and the virtualized non-cloud resources 160 are obtained from the user network. It will be understood that, as described above, the communication between various components of the example testing device 100 and either the cloud or the user network is through the network interface 120.

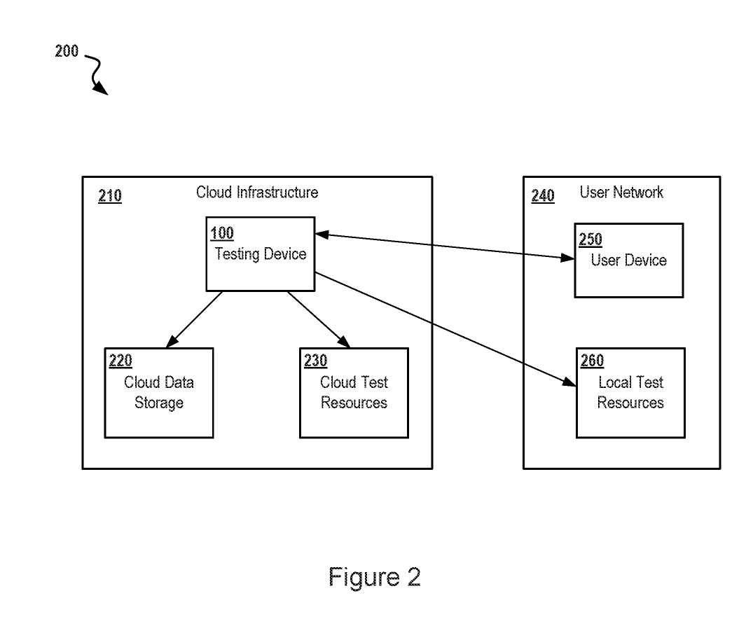

Referring now to FIG. 2, an example system 200 for cloud-based testing including the example testing device 100 of FIG. 1 is illustrated. The example system 200 includes a cloud infrastructure 210 and a user network 240. The cloud infrastructure 210 may include various components that may be distributed among various locations, devices or systems, for example. Such components of the cloud infrastructure may be networked through a wide-area network. For example, the components may be networked through the Internet.

The cloud infrastructure 210 of the example system 200 includes the testing device 100 described above with reference to FIG. 1. In addition, the cloud infrastructure may include various other resources such as cloud data storage 220. The cloud data storage 220 may include data stored on behalf of various clients of a cloud service, for example. The cloud data storage 220 may be formed of various storage arrays, for example, which may be distributed among various locations, facilities or devices.

The cloud infrastructure 210 may further include various other resources, including cloud-computing resources (e.g., processors, etc.), servers, various interconnect devices such as network switches, printers or the like. At least some such resources may be resources required for performing a test requested by a user, for example, and are illustrated in FIG. 2 as cloud test resources 230.

The user network 240 of the example system 200 of FIG. 2 may be any network, such as a local area network or an enterprise network. The user network 240 may include any number of devices, such as user terminals, and may support any number of users. For purposes of simplicity, the example user network 240 of FIG. 1 is shown only with a user device 250 of a user requesting testing.

In operation, a user may use the user device 250 to communicate with the testing device 100 to request a testing. The request may include either sending a test plan to the testing device 100 or allowing the testing device 100 access to the test plan stored within the user network 240. The communication between the testing device 100 and the user device 250 is illustrated in FIG. 2 with a line. As described in greater detail below, the communication between the testing device 10 and the user device 250 may be through the network interface 120 (shown in FIG. 1) of the testing device 100 and may be a secure communication (e.g., via a secure protocol such as HTTPS).

The test plan may dictate resources needed by the testing device to conduct the testing. In this regard, the test plan may include a list of resources that may be identified in any of a variety of manners. For example, the resources may be identified by serial number or an IP address. The identification of the resources may further include a model number or certain characteristics of each resource. For example, the identification may include a capacity of a memory device, for example.

Alternatively, the testing device 100 may obtain information necessary for testing from various databases. For example, the test plan may provide the testing device 100 with a model number, serial number or version number of a resource. The testing device 100 may access a database in the cloud infrastructure 210 which includes specifications of the resource.

As illustrated in the example of FIG. 2, the testing resources may include the cloud test resources 230 describe above. In various examples described herein, at least one resource for testing is a resource in the user network, shown as local test resources 260 in FIG. 2. In this regard, the testing device 100 may communicate with the user network 240 to obtain information related to the local test resources 260.

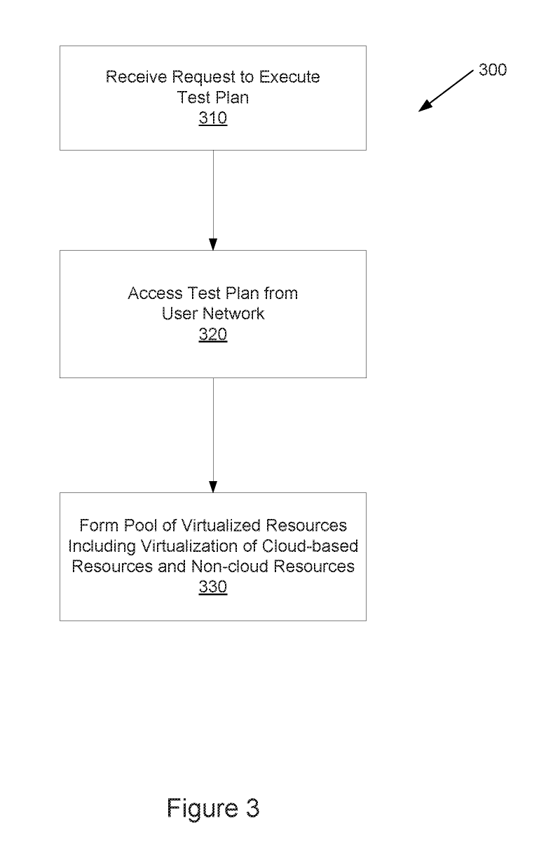

Referring now to FIG. 3, a flow chart illustrates an example process for cloud-based testing. The example process 300 may be implemented by a cloud-based testing service and/or in the example testing device 100 described above with reference to FIGS. 1 and 2. The example process 300 begins with the receipt of a request to execute a test plan (block 310). As described above, the request may be received by the example testing device 100 from a user of a user device 250 in a remote network, such as the user network 240. In various examples, the request from the user device 250, as well as all other communication between the user network 240 and the testing device 100 uses secure communication methods. For example, the communications between the user network 240 and the testing device 100 may use secure sockets layer (SSL) protocols, such as Secure Shell (SSH) or secure hypertext transfer (HTTPS) protocols. In other examples, the communications may include Microsoft Remote Desktop Protocol (RDP).

The request from the user device 250 at block 310 may be accompanied with adjustments to security settings of the user network 240. Such adjustments to the security settings may allow the testing device 100 to obtain access to resources and information in the user network 240 needed by the testing device 100 to satisfy the request. In this regard, the adjustments to the security settings may include, for example, adjustment to firewalls. Further adjustments may allow the example testing device 100 access to established tunnels, virtual local area network (VLAN), virtual private network (VPN) or other methods to access various resources of the user network 240, including the local test resources 260.

Referring again to FIG. 3, at block 320, the example testing device 100 accesses a test plan from the user network 240. In one example, the test plan may be transmitted by the user from the user device 250 to the example testing device 100. For example, in conjunction with the request for testing, the user device 250 may upload the test plan to the example testing device 100. In other examples, the test plan may be stored in a location in the user network 240 or on the user device 250. The storage location of the test plan may be transmitted to the example testing device 100, and the example testing device 100 may use the above-described secure communication methods to obtain access to the test plan.

The example testing device 100 may then form a pool of virtualized resources for testing (block 330). As described above, the virtualized resources may include virtualization of at least one cloud-based resource, such as the cloud-based resources 150 of FIG. 1, and at least one non-cloud resource, such as the non-cloud resources 160 of FIG. 1. As noted above, example testing device 100 may virtualize the various resources in an abstraction layer to facilitate interoperability of the virtualized resources.

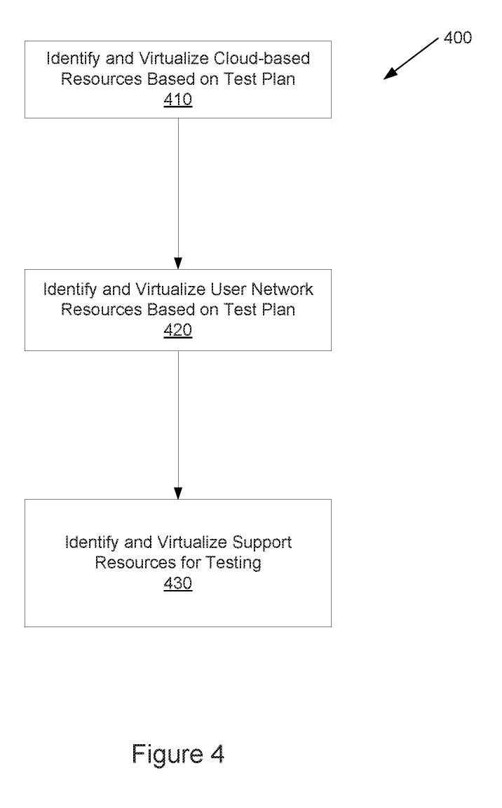

Referring now to FIG. 4, a flow chart illustrates an example process for forming the pool of virtualized resources, as described at block 330 of FIG. 3. In forming the virtualized resources pool, the example testing device 100 may use the test plan to identify the various cloud-based resources 150. The cloud-based resources 150 may be under the control of or otherwise affiliated with the cloud-based testing service associated with the example testing device 100. In this regard, the cloud-based testing service may maintain a database of the various resources. The database may contain specifications of the resources which allow the example testing device 100 to virtualize each resource. Thus, based on the test plan, the example testing device 100 may identify and virtualize the cloud-based resources 150 needed for execution of the test plan (block 410).

In contrast to the cloud-based resources, the non-cloud resources may not be under the control of or otherwise affiliated with the cloud-based testing service associated with the example testing device 100. Thus, the example testing device 100 may not have access to information necessary to virtualize the non-cloud resources. In this regard, the example testing device 100 may obtain the necessary information by accessing the non-cloud resources by accessing the user network 240 through one or more of the secure communication methods described above. Thus, based on the test plan, the example testing device 100 may identify and virtualize the non-cloud resources 160 needed for execution of the test plan (block 420).

In addition to resources indicated in the test plan, the example testing device 100 may identify and virtualize at least one support resource that is needed for testing purposes (block 430). In this regard, the support resources are generally available to the cloud-based testing service and the example testing device 100. Accordingly, the example testing device 100 can readily virtualize such support resources. In various example, such test support resources may generally include various sharable resources that may be leveraged by multiple users and/or test plans executing in parallel. Examples of test support resources may include, but not limited to, an operating system provisioning service, virtual machine host, enclosure control entities, network traffic generators, log and test result storage devices, and source control repository systems, for example. With the virtualized resource pool 140 (shown in FIG. 1) formed, the example testing device 100 may execute the test plan and provide the results to the user device 250.

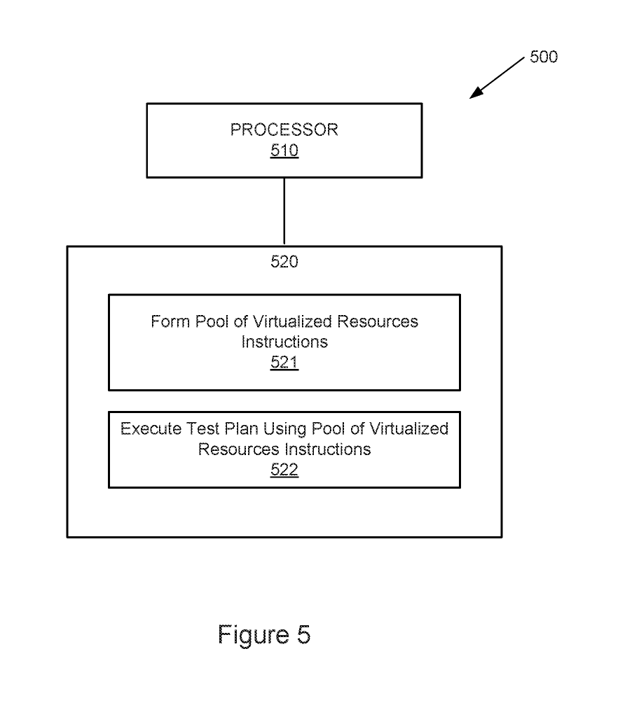

FIG. 5 illustrates a block diagram of an example system with a computer-readable storage medium including example instructions executable by a processor to provide cloud-based testing. The system 500 may be a computer system, such as a desktop, laptop or any other computing device. The system 500 includes a processor 510 and a computer-readable storage medium 520. The computer-readable storage medium 520 is a non-transitory medium and includes example instructions 521 and 522 executable by the processor 510 to perform various functionalities described herein.

The example instructions include forming pool of virtualized resources instructions 521. The instructions 521 may cause the processor 510 to use a test plan to identify and virtualize various resources. As described above, the pool of virtualized resources includes virtualization of at least one cloud-based resource and at least one non-cloud resource. Further, in some examples, the resources may be virtualized in an abstraction layer.

The example instructions further include executing a test plan using the pool of virtualized resources instructions 522. Upon execution of the test plan, the results may be provided to a user requesting the testing, such as the user device 250 of FIG. 2.

Thus, in accordance with various examples described herein, a single testing solution can be used to execute a test plan which includes resources in the cloud and within the user's network. A single solution allows testing of disparate resources in an efficient manner. Since the example test plans may refer to virtualized resources, various details of each resource (e.g., physical location) may be abstracted.

Software implementations of various examples can be accomplished with standard programming techniques with rule-based logic and other logic to accomplish various database searching steps or processes, correlation steps or processes, comparison steps or processes and decision steps or processes.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

What is claimed is:

1. A device, comprising:
a processor to execute a test plan obtained from a user of a user network; and
a test platform having a pool of virtualized resources identified based on the test plan, the pool of virtualized resources including virtualization of at least one cloud-based resource and at least one non-cloud resource, the virtualization of the at least one non-cloud resource being a virtualization of a resource from the user network.

2. The device of claim 1, wherein the pool of virtualized resources is formed in an abstraction layer.

3. The device of claim 1, comprising a network interface to provide secure communication with the user network.

4. The device of claim 1, wherein the processor is to identify the at least one cloud-based resource and the at least one non-cloud resource based on the test plan.

5. The device of claim 1, wherein the processor is to identify and virtualize at least one test support resource.

6. A method, comprising:
receiving, by a cloud-based server, a request from a user to execute a test plan;
accessing, by the cloud-based server, the test plan from a network of the user, the test plan including at least one cloud-based resource and at least one non-cloud resource; and
forming a pool of virtualized resources, the pool of virtualized resources including virtualization of the at least one cloud-based resource and the at least one non-cloud resource,
wherein forming the pool of virtualized resources includes accessing a local network of the user to virtualize the at least one non-cloud resource.

7. The method of claim 6, wherein forming the pool of virtualized resources comprises:
identifying and virtualizing at least one cloud-based resource based on the test plan; and
identifying and virtualizing at least one non-cloud resource based on the test plan.

8. The method of claim 7, wherein forming the pool of virtualized resources comprises:
identifying and virtualizing at least one test support resource.

9. The method of claim 6, wherein the pool of virtualized resources is formed in an abstraction layer.

10. The method of claim 6, wherein the receiving the request and the accessing the test plan include using secure communication with the network of the user.

11. A non-transitory computer-readable storage medium including instructions executable by a processor of a computing system, the instructions causing the processor to:
form a pool of virtualized resources in an abstraction layer, the pool of virtualized resources being identified based on a test plan from a user and including virtualization of at least one cloud-based resource and at least one non-cloud resource, wherein virtualization of the at least one non-cloud resource includes accessing a local network of the user to virtualize the at least one non-cloud resource; and
execute the test plan using the pool of virtualized resources.

12. The non-transitory computer-readable storage medium of claim 11, wherein the instructions to form the pool of virtualized resources comprise instructions to:
identify and virtualize at least one cloud-based resource based on the test plan; and
identify and virtualize at least one non-cloud resource based on the test plan.

13. The non-transitory computer-readable storage medium of claim 12, wherein the instructions to form the pool of virtualized resources comprise instructions to:
identify and virtualize at least one test support resource.

14. The -transitory computer-readable storage medium of claim 11, wherein the pool of virtualized resources is formed in an abstraction layer.

15. The -transitory computer-readable storage medium of claim 11, wherein the test plan is accessed using secure communication with the local network.
